(19) United States
(12) Patent Application Publication
(10) Pub. No.: US 2024/0089907 A1
(43) Pub. Date: Mar. 14, 2024

(54) METHOD AND NON-TRANSITORY COMPUTER READABLE MEDIUM

(71) Applicant: TOYOTA JIDOSHA KABUSHIKI KAISHA, Aichi-ken (JP)

(72) Inventors: Kai TANAKA, Kumamoto-shi (JP); Junpei OKAMOTO, Sayama-shi (JP); Makoto KINOSHITA, Tokyo-to (JP)

(21) Appl. No.: 18/461,506

(22) Filed: Sep. 6, 2023

(30) Foreign Application Priority Data
Sep. 14, 2022 (JP) 2022-146530

(51) Int. Cl. H04W 64/00

(52) U.S. Cl. CPC H04W 64/003

(57) ABSTRACT

A method performed by a terminal apparatus 10 in accordance with an application program configured to be initiated upon being designated as a destination for sharing electronic content, the method including acquiring shared information set for the electronic content, automatically entering the shared information in an input field in which a user can enter information, acquiring location information on a spot, and storing spot information, which includes information entered in the input field and the acquired location information, so that the spot information can be viewed by the user.

### CROSS-REFERENCE TO RELATED APPLICATION

This application claims priority to Japanese Patent Application No. 2022-146530 filed on Sep. 14, 2022, the entire contents of which are incorporated herein by reference.

### TECHNICAL FIELD

The present disclosure relates to a method and a non-transitory computer readable medium.

### BACKGROUND

Technology for storing information in computers so that the information can be viewed by users is known. For example, Patent Literature (PTL) 1 discloses a memo page information display system that includes a terminal apparatus and a server apparatus communicably connected via a network and that displays memo page information generated based on web text extraction results.

### CITATION LIST

### Patent Literature

PTL 1: JP 2008-059453 A

### SUMMARY

There is room for improvement with respect to technology for storing information in computers so that the information can be viewed by users.

It would be helpful to improve technology for storing information in computers so that the information can be viewed by users.

A method according to an embodiment of the present disclosure is a method performed by a terminal apparatus in accordance with an application program configured to be initiated upon being designated as a destination for sharing electronic content, the method including:
acquiring shared information set for the electronic content;
automatically entering the shared information in an input field in which a user can enter information;
acquiring location information on a spot; and
storing spot information so that the spot information can be viewed by the user, the spot information including information entered in the input field and the acquired location information.

A non-transitory computer readable medium according to an embodiment of the present disclosure is a non-transitory computer readable medium storing an application program configured to be initiated upon being designated as a destination for sharing electronic content, the application program configured to cause a terminal apparatus to execute operations, the operations including:
acquiring shared information set for the electronic content;
automatically entering the shared information in an input field in which a user can enter information;
acquiring location information on a spot; and
storing spot information so that the spot information can be viewed by the user, the spot information including information entered in the input field and the acquired location information.

According to an embodiment of the present disclosure, technology for storing information in computers so that the information can be viewed by users is improved.

### BRIEF DESCRIPTION OF THE DRAWINGS

In the accompanying drawings:

FIG. 1 is a block diagram illustrating a schematic configuration of a system according to an embodiment of the present disclosure;

FIG. 2 is a diagram illustrating a first example of a screen displayed on a terminal apparatus;

FIG. 3 is a diagram illustrating a second example of the screen displayed on the terminal apparatus;

FIG. 4 is a block diagram illustrating a schematic configuration of the terminal apparatus;

FIG. 5 is a block diagram illustrating a schematic configuration of a server; and

FIG. 6 is a flowchart illustrating operations of the terminal apparatus.

### DETAILED DESCRIPTION

Hereinafter, an embodiment of the present disclosure will be described.

### Outline of Embodiment

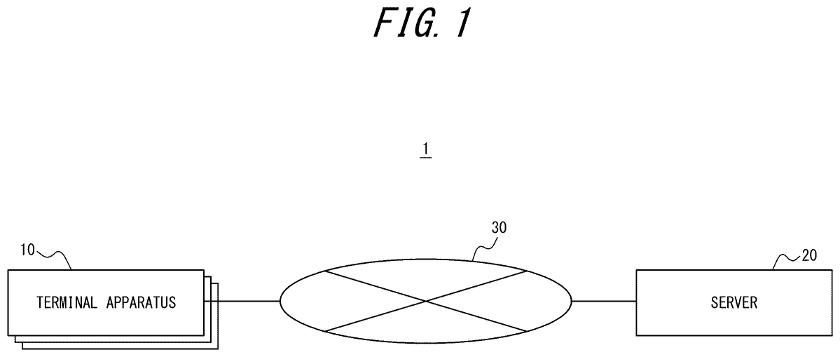

An outline of a system 1 according to an embodiment of the present disclosure will be described with reference to FIG. 1. The system 1 includes one or more terminal apparatuses 10 and a server 20. Each terminal apparatus 10 and the server 20 can communicate with each other via a communication line 30 such as the Internet or a mobile communication network, for example.

Each terminal apparatus 10 is, for example, a computer such as a personal computer (PC), a smartphone, or a tablet terminal, and is used by a user. The server 20 is configured to include one computer or a plurality of computers that can communicate with each other.

In the present embodiment, an application program dedicated to the system 1 (hereinafter referred to as “dedicated application”) is installed in each terminal apparatus 10. The dedicated application has the function (hereinafter referred to as “spot memo function”) of allowing the use to view and edit information (hereinafter referred to as “spot information”) stored in connection with any spot on a map. The spot information may include, for example, a URL, text data, image data, or audio data, or a combination of these. The spot information may be stored in the terminal apparatus 10 or in the server 20. In a case in which the spot information is stored on the server 20, the spot information may include public information that can be viewed and edited by all users of the system 1 and private information that can be viewed and edited only by the individual user.

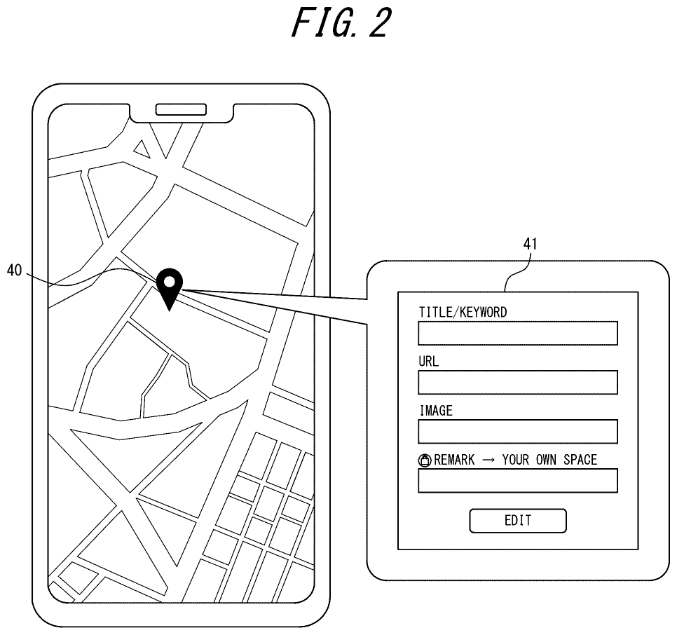

A specific example of a use aspect of the spot memo function will be described with reference to FIG. 2. FIG. 2 illustrates an example of a screen displayed on the terminal apparatus 10 with a dedicated application running in the foreground. A user can designate any spot 40 on a map displayed on the screen of the terminal apparatus 10. When the spot 40 is designated, spot information 41 for the spot 40 is displayed on the screen of the terminal apparatus 10. The user can then freely view and edit the spot information 41 displayed on the screen. The spot information 41 illustrated in FIG. 2 includes four items of “title/keyword”, “URL”, “image”, and “remark”, but not limited to these and may include any items. In the example illustrated in FIG. 2, the items of “title/keyword”, “URL”, and “image” each correspond to public information described above, while the item of “remark” corresponds to private information described above. In an initial state, no information may have been entered for each item of the spot information 41, or related information on the spot 40 (e.g., the name or the like of the spot 40) registered in map data may have been entered in advance. When editing the spot information 41, a graphical user interface (GUI), such as an input field in which the user can enter information, may be displayed for each item included in the spot information 41.

The dedicated application according to the present embodiment may have any function different from the spot memo function described above. For example, the dedicated application may have a route search function, a transportation reservation function, a map viewing function, or the like. Each function of the dedicated application may be realized by the terminal apparatus 10 alone or by the collaboration of the terminal apparatus 10 and the server 20.

The terminal apparatus 10 also has the function (hereinafter referred to as information sharing function) of sharing information among application programs installed on its own apparatus. For example, while the user is viewing desired electronic content using a first application program, when a second application program is designated as a destination for sharing the electronic content, shared information set for the electronic content is passed from the first application program to the second application program. The information sharing function may be provided by a system program, such as an operating system (OS) or middleware.

The “electronic content” is any content provided to users via computers, including web pages, posted information in Social Networking Services (SNS), distributed video in video distribution services, and the like, but are not limited to these. The “shared information” is metadata that is set for the electronic content, including a URL, text data, image data, or audio data, or a combination thereof, for example, but is not limited to these. The shared information may be described, for example, in the form of Open Graph Protocol (OGP).

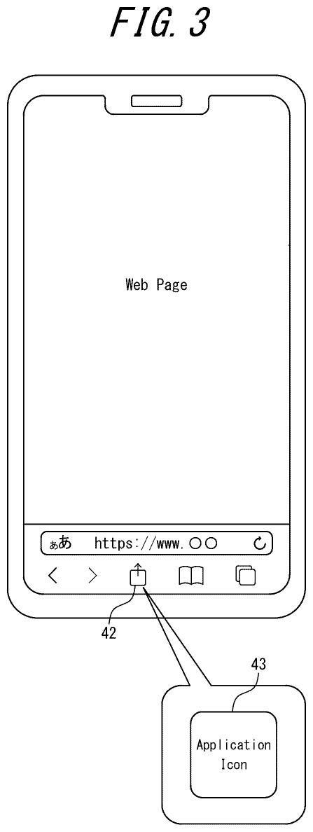

The dedicated application according to the present embodiment is configured (implemented) to be initiated upon being designated as a destination for sharing electronic content. With reference to FIG. 3, a specific example of operations to designate the dedicated application as a destination for sharing electronic content (e.g., a web page) from another application program (e.g., a general purpose web browser) installed on the terminal apparatus 10 will be described. FIG. 3 illustrates an example of a screen displayed on the terminal apparatus 10 with a web browser running in the foreground. The user can tap a sharing button 42 on the web browser while viewing a desired web page. When the sharing button 42 is tapped, icons 43 of application programs that can be selected as destinations for sharing the web page are displayed. When an icon 43 of the dedicated application, among the displayed icons 43, is tapped, the dedicated application is initiated in the foreground, and shared information set for the web page is passed from the web browser to the dedicated application.

An outline of the present embodiment is described here, and details thereof will be described later. The terminal apparatus 10 performs the following operations in accordance with an application program (dedicated application) that is configured to be initiated upon being designated as a destination for sharing electronic content. The terminal apparatus 10 acquires shared information set for the electronic content. The terminal apparatus 10 automatically enters the shared information in input fields in which a user can enter information. The terminal apparatus 10 acquires location information on a spot. The terminal apparatus 10 then stores spot information, which includes information entered in the input fields and the acquired location information, so that the spot information can be viewed by the user.

According to the present embodiment, for example, while a user is viewing electronic content (e.g., a web page) using another application program (e.g., a web browser), the user designates a dedicated application as a destination for sharing the electronic content. Shared information set for the electronic content is thereby entered in input fields. Then, spot information, which includes information entered in the input fields, is stored as described above. Thus, technology for storing information in computers so that the information can be viewed by users is improved in that the spot information including the shared information on the electronic content can be stored with the simple operation of designating the dedicated application as the destination for sharing the electronic content.

Next, components of the system 1 will be described in detail.

(Configuration of Terminal Apparatus)

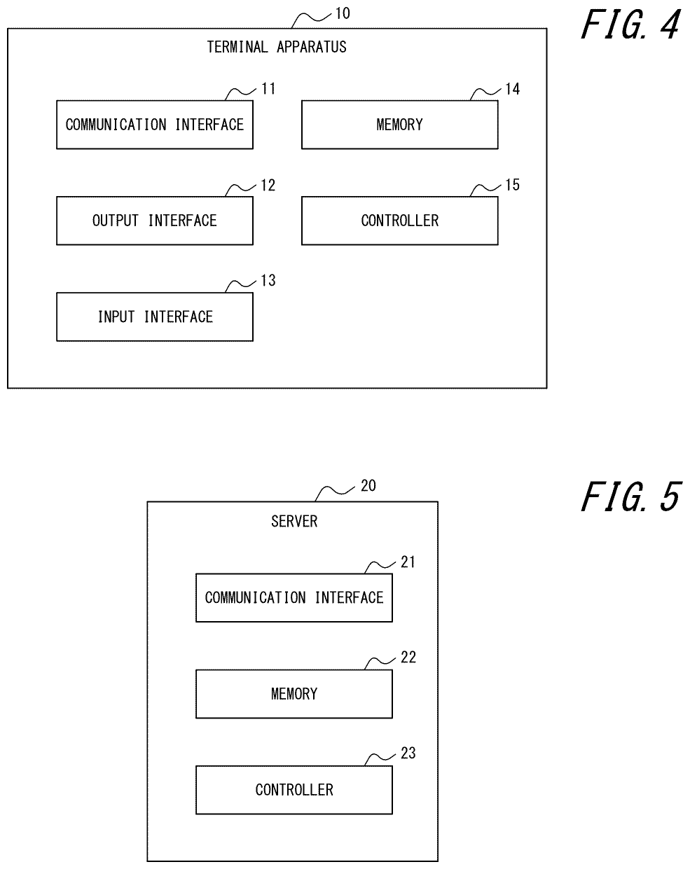

As illustrated in FIG. 4, the terminal apparatus 10 includes a communication interface 11, an output interface 12, an input interface 13, a memory 14, and a controller 15.

The communication interface 11 includes at least one communication interface for connecting to the communication line 30. The communication interface is compliant with mobile communication standards such as the 4th generation (4G) standard and the 5th generation (5G) standard, a wired local area network (LAN) standard, or a wireless LAN standard, for example, but not limited to these, and may be compliant with any communication standard.

The output interface 12 includes at least one output device for outputting information. The output device is a display for outputting information as video, a speaker for outputting information as audio, or the like, for example, but is not limited to these. Alternatively, the output interface 12 may include an interface for connecting to an external output device.

The input interface 13 includes at least one input device for detecting input operations by a user. The input device is a physical key, a capacitive key, a mouse, a touch panel, a touch screen integrally provided with a display of the output interface 12, a microphone, or the like, for example, but is not limited to these. Alternatively, the input interface 13 may include an interface for connecting to an external input device.

The memory 14 includes one or more memories. The memories are semiconductor memories, magnetic memories, optical memories, or the like, for example, but are not limited to these. The memories included in the memory 14 may each function as, for example, a main memory, an auxiliary memory, or a cache memory. The memory 14 stores any information to be used for operations of the terminal apparatus 10. For example, the memory 14 may store a system program, an application program, map data, and the like. In the present embodiment, the memory 14 stores the dedicated application described above. The dedicated application may be stored at the time of manufacture of the terminal apparatus 10, or downloaded from a predetermined application distribution server via the communication interface 11 and the communication line 30.

The controller 15 includes at least one processor, at least one programmable circuit, at least one dedicated circuit, or a combination of these. The processor is a general purpose processor such as a central processing unit (CPU) or a graphics processing unit (GPU), or a dedicated processor that is dedicated to specific processing, for example, but is not limited to these. The programmable circuit is a field-programmable gate array (FPGA), for example, but is not limited to this. The dedicated circuit is an application specific integrated circuit (ASIC), for example, but is not limited to this. The controller 15 controls the operations of the entire terminal apparatus 10.

(Configuration of Server)

As illustrated in FIG. 5, the server 20 includes a communication interface 21, a memory 22, and a controller 23.

The communication interface 21 includes at least one communication interface for connecting to the communication line 30. The communication interface is compliant with, for example, a mobile communication standard, a wired LAN standard, or a wireless LAN standard, but not limited to these, and may be compliant with any communication standard.

The memory 22 includes one or more memories. The memories included in the memory 22 may each function as, for example, a main memory, an auxiliary memory, or a cache memory. The memory 22 stores any information to be used for operations of the server 20. For example, the memory 22 stores a system program, an application program, map information, embedded software, a database, and the like.

The controller 23 includes at least one processor, at least one programmable circuit, at least one dedicated circuit, or a combination of these. The controller 23 controls the operations of the entire server 20.

(Operations of Terminal Apparatus)

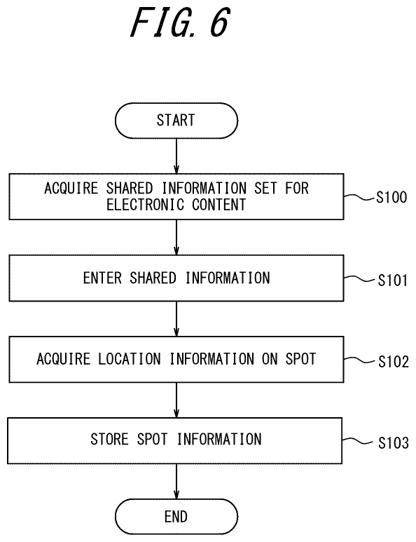

With reference to FIG. 6, operations of the terminal apparatus 10 in accordance with a dedicated application will be described. These operations start, for example, while a user is viewing electronic content (e.g., a web page) using another application program (e.g., a web browser), when the dedicated application is designated as a destination for sharing the electronic content. However, conditions and/or timing in which these operations start are not limited to this example.

Step S100: The controller 15 of the terminal apparatus 10 acquires shared information set for electronic content.

Specifically, the controller 15 acquires, using an information sharing function described above, the shared information set for the electronic content (e.g., a web page) from another application program (e.g., a web browser).

Step S101: The controller 15 automatically enters the shared information in input fields in which a user can enter information.

The controller 15 may modify, according to user operations, the information (here, the shared information) that has been entered in the input fields.

Step S102: The controller 15 acquires location information on a spot.

Any method can be adopted to acquire location information on a spot. For example, the controller 15 may read map data stored in the memory 14 and display a map on a screen of a display of the output interface 12. The controller 15 may then identify a spot designated by the user on the map and acquire location information on the spot from the map data.

Alternatively, for example, the controller 15 may acquire location information on a spot based on the shared information acquired in step S100. In detail, the controller 15 acquires location information on a spot identified from a URL, text data, image data, or audio data, or a combination thereof included in the shared information. Specifically, in a case in which the shared information includes location information on a spot, the controller 15 may directly acquire the location information on the spot from the shared information. Alternatively, in a case in which the shared information includes image data, the controller 15 may identify, using image retrieval AI, for example, a spot whose scenery coincides with or is similar to the image data, and acquire location information on the spot from map data. Alternatively, in a case in which the shared information includes the name, address, or URL of a spot, the controller 15 may identify the name, address, or URL of the spot using information processing such as keyword extraction, natural language processing, image recognition, or audio recognition, for example, and acquire, from map data, location information on the spot that matches the name, address, or URL.

Step S103: The controller 15 stores spot information, which includes information entered in the input fields and the location information on the spot acquired in step S102, so that the spot information can be viewed by the user.

The spot information may be stored in the memory 14 of the terminal apparatus 10 or in the memory 22 of the server 20. The spot information may be stored as public information or private information, as described above. In either case, the user of the terminal apparatus 10 can view the stored spot information.

As described above, the terminal apparatus 10 according to the present embodiment performs the following operations in accordance with an application program (dedicated application) that is configured to be initiated upon being designated as a destination for sharing electronic content. The terminal apparatus 10 acquires shared information set for the electronic content. The terminal apparatus 10 automatically enters the shared information in input fields in which a user can enter information. The terminal apparatus 10 acquires location information on a spot. The terminal apparatus 10 then stores spot information, which includes information entered in the input fields and the acquired location information, so that the spot information can be viewed by the user.

According to such a configuration, technology for storing information in computers so that the information can be viewed by users is improved in that the spot information including the shared information on the electronic content can be stored with the simple operation of designating the dedicated application as the destination for sharing the electronic content.

While the present disclosure has been described with reference to the drawings and examples, it should be noted that various modifications and revisions may be implemented by those skilled in the art based on the present disclosure. Accordingly, such modifications and revisions are included within the scope of the present disclosure. For example, functions or the like included in each component, each step, or the like can be rearranged without logical inconsistency, and a plurality of components, steps, or the like can be combined into one or divided.

For example, an embodiment in which the server 20 executes some or all of the operations that are executed by the terminal apparatus 10 in the embodiment described above can be implemented.

For example, an embodiment in which a general purpose computer functions as the terminal apparatuses 10 according to the above embodiment can also be implemented. Specifically, a program in which processes for realizing the functions of the terminal apparatus 10 according to the above embodiment are written may be stored in a memory of a general purpose computer, and the program may be read and executed by a processor. Accordingly, the present disclosure can also be implemented as a program executable by a processor, or a non-transitory computer readable medium storing the program.

1. A method performed by a terminal apparatus in accordance with an application program configured to be initiated upon being designated as a destination for sharing electronic content, the method comprising:
acquiring shared information set for the electronic content;
automatically entering the shared information in an input field in which a user can enter information;
acquiring location information on a spot; and
storing spot information so that the spot information can be viewed by the user, the spot information including information entered in the input field and the acquired location information.

2. The method according to claim 1, further comprising displaying a map on a screen,
wherein the terminal apparatus is configured to acquire the location information on the spot that is designated by the user on the map.

3. The method according to claim 1, wherein the terminal apparatus is configured to acquire the location information on the spot based on the shared information.

4. The method according to claim 3, wherein the terminal apparatus is configured to acquire the location information on the spot that is identified from a URL, text data, image data, or audio data included in the shared information, or from a combination of the URL, the text data, the image data, and the audio data.

5. A non-transitory computer readable medium storing an application program configured to be initiated upon being designated as a destination for sharing electronic content, the application program configured to cause a terminal apparatus to execute operations, the operations comprising:
acquiring shared information set for the electronic content;
automatically entering the shared information in an input field in which a user can enter information;
acquiring location information on a spot; and
storing spot information so that the spot information can be viewed by the user, the spot information including information entered in the input field and the acquired location information.
